(19) United States
(12) Patent Application Publication
(10) Pub. No.: US 2021/0342098 A1
(43) Pub. Date: Nov. 4, 2021

(54) SYSTEM AND METHOD FOR STORING AND RETRIEVING DATA

(71) Applicant: IONIR SYSTEMS LTD., Tel Aviv (IL)

(72) Inventors: Nir PELEG, Tel Aviv (IL); Or SAGI, Tel-Aviv (IL)

(21) Appl. No.: 17/246,656

(22) Filed: May 2, 2021

Related U.S. Application Data
(60) Provisional application No. 63/019,349, filed on May 3, 2020.

(51) Int. Cl. G06F 3/06

(52) U.S. Cl. CPC G06F 3/0659; G06F 3/0673; G06F 3/0604

(57) ABSTRACT

A system and method for storing and retrieving data may include receiving, by a controller, data to be stored in a storage system; associating the data with a key and storing the data in the storage system; providing the key, by the controller, to a processing unit; and using the key, by the processing unit, to retrieve the data from the storage system.

### CROSS REFERENCE TO RELATED APPLICATIONS

This application claims priority to and the benefit of Provisional Application No. 63/019,349, filed May 3, 2020 the entire contents of which are incorporated herein by reference in its entirety.

### FIELD OF THE INVENTION

The present invention relates generally to storing and retrieving data. More specifically, the present invention relates to separating a data write path from a data read path.

### BACKGROUND OF THE INVENTION

In order to access large data sets, current and/or known systems use file interfaces, protocols or systems, e.g., Network File System (NFS) or Remote Direct Memory Access (RDMA). This is mostly due to legacy reasons. However, file interfaces such as NFS and RDMA are unsuitable for embedded systems such as graphics processing unit (GPU) and field-programmable gate array (FPGA). Otherwise described, file system interfaces do not lend themselves to being easily embedded, included or used in, a GPU or FPGA unit.

### SUMMARY OF THE INVENTION

An embodiment for storing and retrieving data may include receiving, by a controller, a data element to be stored in a storage system; associating the data element with a key and storing the data element in the storage system; providing the key, by the controller, to a processing unit; and using the key, by the processing unit, to retrieve the data element from the storage system.

The controller and the processing unit may be included in the same chip. The controller may be included in a first chip and the processing unit may be included in a second chip. The processing unit may be any one of: a graphics processing unit (GPU), a field-programmable gate array (FPGA) and an application-specific integrated circuit (ASIC).

Storing the data element by the controller may be according to a write path which is different from a read path used for retrieving the data element by the processing unit. A write path may include a first set of physical lines and a read path may include a second, different and separate, set of physical lines. Providing the key may include directly accessing, by a controller, a memory of a processing unit.

An embodiment may include associating, by a controller, a data element with a key and storing the data element in a storage system; and commanding a processing unit to process the data element. Commanding a processing unit to process the data element may include providing the key and the key may be used, by the processing unit, to retrieve the data element. An embodiment may include a controller adapted to provide keys to a plurality of processing units.

An embodiment may include receiving, by a controller, a set of data elements to be stored in a storage system; associating the set of data elements with a respective set of keys and storing the data elements in the storage system; selecting at least one of the keys, by a controller, and providing the selected key to a selected one of a set of processing units; and using the key, by selected processing unit, to retrieve a data element included in the set, from the storage system.

Other aspects and/or advantages of the present invention are described herein.

### BRIEF DESCRIPTION OF THE DRAWINGS

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not of limitation in the figures of the accompanying drawings, in which like reference numerals indicate corresponding, analogous or similar elements, and in which:

FIG. 1 shows a block diagram of a computing device according to illustrative embodiments of the present invention;

FIG. 2 is an overview of a prior art system;

FIG. 3 is an overview of a system according to illustrative embodiments of the present invention; and

FIG. 4 shows a flowchart of a method according to illustrative embodiments of the present invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

Unless explicitly stated, the method embodiments described herein are not constrained to a particular order in time or to a chronological sequence. Additionally, some of the described method elements can occur, or be performed, simultaneously, at the same point in time, or concurrently. Some of the described method elements may be skipped, or they may be repeated, during a sequence of operations of a method.

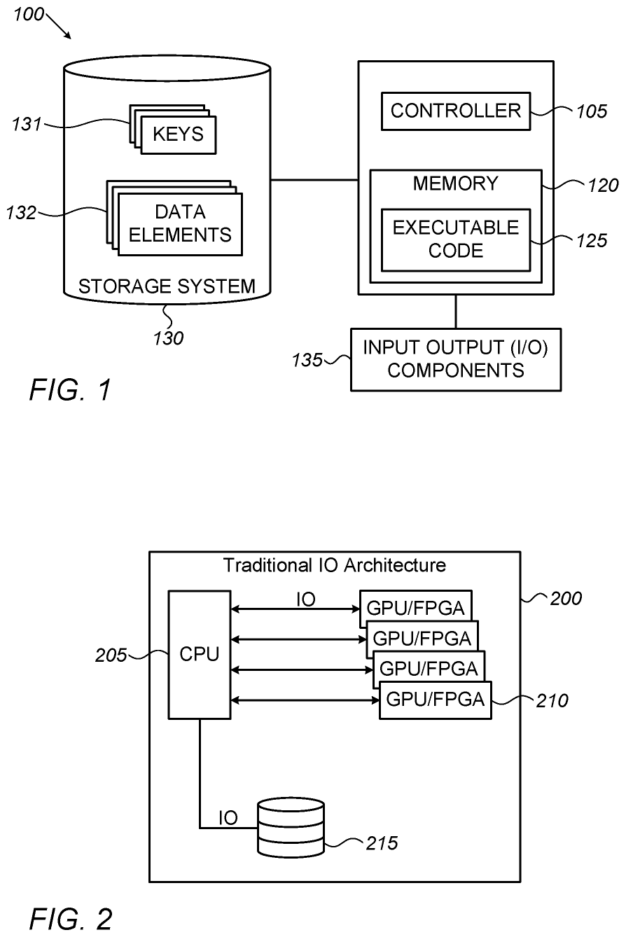

Reference is made to FIG. 1, showing a non-limiting, block diagram of a computing device or system 100 that may be used to storing and retrieving data according to some embodiments of the present invention. Computing device 100 may include a controller 105 that may be a hardware controller. For example, computer hardware processor or hardware controller 105 may be, or may include, a central processing unit processor (CPU), GPU, an FPGA, a multi-purpose or specific processor, a microprocessor, a microcontroller, a programmable logic device (PLD), an application-specific integrated circuit (ASIC), a chip or any suitable computing or computational device. Computing system 100 may include a memory 120, executable code 125, a storage system 130 and input/output (1/0) components 135. Controller 105 (or one or more controllers or processors, possibly across multiple units or devices) may be configured (e.g., by executing software or code) to carry out methods described herein, and/or to execute or act as the various modules, units, etc., for example by executing software or by using dedicated circuitry. More than one computing devices 100 may be included in, and one or more computing devices 100 may be, or act as the components of, a system according to some embodiments of the invention.

Memory 120 may be a hardware memory. For example, memory 120 may be, or may include machine-readable media for storing software e.g., a Random-Access Memory (RAM), a read only memory (ROM), a memory chip, a Flash memory, a volatile and/or non-volatile memory or other suitable memory units or storage units. Memory 120 may be or may include a plurality of, possibly different memory units. Memory 120 may be a computer or processor non-transitory readable medium, or a computer non-transitory storage medium, e.g., a RAM. Some embodiments may include a non-transitory storage medium having stored thereon instructions which when executed cause the processor to carry out methods disclosed herein.

Executable code 125 may be an application, a program, a process, task or script. A program, application or software as referred to herein may be any type of instructions, e.g., firmware, middleware, microcode, hardware description language etc. that, when executed by one or more hardware processors or controllers 105, cause a processing system or device (e.g., system 100) to perform the various functions described herein.

Executable code 125 may be executed by controller 105 possibly under control of an operating system. For example, executable code 125 may be an application that manages, or participates in a flow of storing and retrieving computerized (e.g. digital) data as further described herein. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein.

Storage system 130 may be or may include, for example, a hard disk drive, a CD-Recordable (CD-R) drive, a Blu-ray disk (BD), a universal serial bus (USB) device or other suitable removable and/or fixed storage unit. As shown, storage system 130 may include keys 131 and computer data elements 132 (collectively referred to hereinafter as keys 131 or data elements 132 or individually as a key 131 or a data element 132, merely for simplicity purposes). As used herein, the terms “data element” and “data object” may mean the same thing and may be used interchangeably.

Keys 131 may be any suitable digital data structure or construct or computer data object that enables storing, retrieving and modifying values. For example, keys 131 may be, or may be stored in, files, entries in a table or list in a database in storage system 130. Content may be loaded from storage system 130 into memory 120 where it may be processed by controller 105. For example, a key 131 stored by controller 105 in association with or linked to data, e.g., in a memory or storage accessible to a GPU, may be loaded into a memory 120 of the GPU and used, by the GPU, in order to access data as further described herein. Data elements may be any digital objects or entities, e.g., data elements may be files in a file system, objects in an object-based storage or database and the like.

In some embodiments, some of the components shown in FIG. 1 may be omitted. For example, memory 120 may be a non-volatile memory having the storage capacity of storage system 130. Accordingly, although shown as a separate component, storage system 130 may be embedded or included in system 100, e.g., in memory 120.

1/0 components 135 may be any suitable input/output components, e.g., a bus connected to a memory and/or any other suitable input/output devices. Any applicable 1/0 components may be connected to computing device 100 as shown by 1/0 components 135, for example, a wired or wireless network interface card (NIC), a universal serial bus (USB) device or an external hard drive may be included in 1/0 components 135.

A system according to some embodiments of the invention may include components such as, but not limited to, a plurality of central processing units (CPU), a plurality of GPUs, a plurality of FPGAs or any other suitable multi-purpose or specific processors, controllers, microprocessors, microcontrollers, PLDs or ASICs. A system according to some embodiments of the invention may include a plurality of input units, a plurality of output units, a plurality of memory units, and a plurality of storage units. A system may additionally include other suitable hardware components and/or software components.

Reference is made to FIG. 2, an overview of a prior art system 200. Aspects of prior art system 200 may be used with embodiments of the present invention. As shown, in a traditional 1/0 system, method or architecture 200, to access data (e.g., data elements 132) in a storage 215, GPUs or FPGAs 210 must go through a CPU 205. Otherwise described, there is no direct 1/0 between the GPUs and/or FPGAs and the storage system 215. In operation of system 200, CPU 205 writes data elements 132 to storage 215 and, when requested by a GPU 210, CPU 205 reads (retrieves) the data from storage 215 and provides or transmits the retrieved data to the GPU.

As further described, some embodiments of the invention improve the field of computer data storage and databases by providing a number of advantages. For example, embodiments of the invention provide and enable a separation of a data read path from the data write path. Embodiments of the invention provide and enable an optimized read path, that is, embodiments of the invention provide GPUs 210 and other processing units with direct access (or direct 1/0) to storage system, e.g., in some embodiments, a GPU 210 can access storage system 215 directly and not via CPU 205 as shown in FIG. 2.

Moreover, some embodiments of the invention improve the field of data storage by relieving GPUs and FPGAs 210 from the burden of using (or supporting) traditional file interfaces, protocols or systems. For example, instead of requesting a file (or data object) using the NFS or RDMA protocols, convention or architecture (e.g., using the Portable Operating System Interface (POSIX) standard), a GPU 210 may be enabled, by some embodiments of the invention, to use a key (or associated value) in order to retrieve a data object. Accordingly, storage resources are spared since the amount of data required for using POSIX, NFS or RDMA is huge compared to a key and value, computational resources are spared since the amount of computations (e.g., clock cycles) need when using POSIX, NFS or RDMA is huge compared to key/value computations.

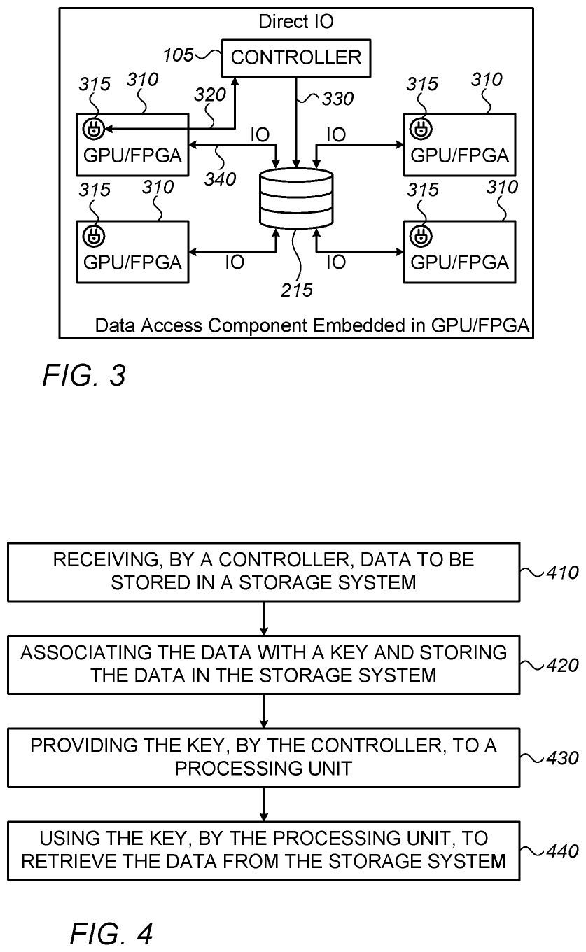

Reference is made to FIG. 3, an overview of a system 300 and flows according to some embodiments of the present invention. As shown, a system 300 may include a plurality of processing units (PU) 310 each including a data access component (DAC) 315 and a controller 105. PUs 310 and DACs 315 may be collectively referred to hereinafter as PUs 310 and/or DACs 315 or individually as PU 310 and/or DAC 315, merely for simplicity purposes).

As shown by left right arrow 320, controller 105 (e.g., CPU 205) may be connected to DACs 315, e.g., the connection may be a computer data bus enabling controller 105 to write keys and/or values to DAC 315, delete keys or values in DAC 315 or modify keys and/or values in DAC 315. As shown by arrow 330, controller 105 may be connected to storage system 215, e.g., a data bus may enable controller 105 to store or write data elements 132, keys 131 and/or key values in storage system 215. Data stored in storage system 215, e.g., by controller 105, may be, for example, data elements 132 as described. Data retrieved, or read from storage system 215, e.g., by DACs 315, may be, for example, data elements 132 as described. For

[symbol]

As further shown by left right arrow 340, GPUs 315 may be connected to storage system 215, e.g., the connection may be a computer data bus enabling a GPU 310 to retrieve data (e.g., data elements 132) from storage system 215. For the sake of clarity and simplicity, arrows 320, 330 and 340, which represent connections between units that enable transferring data or digital information, may be referred to herein as connections 320, 330 and 340 respectively.

For the sake of clarity, numerals 320 and 340 are shown for one GPU 310 and DAC 315, however, it will be understood that controller 105 may be connected to any number of DACs 315 in GPUs 310 (e.g., all GPUs 310 shown in FIG. 3) and that a connection 340 as described herein may connect any number of GPUs 310 (e.g., all GPUs 310 shown in FIG. 3) to storage system 215.

In some embodiments, a method of storing and retrieving data may include receiving, by a controller, a data element to be stored in a storage system, associating or linking the data element with a key and storing the data element in the storage system, transmitting or providing the key, by the controller, to a processing unit, and, using the key, by the processing unit, to retrieve the data element from the storage system.

For example, controller 105 may receive a data element, e.g., a data element 132 that includes for example an image, to be written to storage system 215 and may associate or link the data element with a key. A key as referred to herein may be any code, number or value. For example, using techniques known in the art (e.g., a hash function applied to information in a data element 132), controller 105 may generate a unique key for data elements 132 it stores in storage system 215 such that no two data elements in storage system 215 are associated with the same key (or same key value). A key (or key value) may be unique within a specific instantiation of the invention, but not be unique when compared with the universe of numbers of data stored on all existing computer systems.

An association of a key or key value with a data element stored in storage system 215, e.g., an association of a key 131 with a data element 132, may be, or may be achieved by, associating the data element, in a database, with the key such that, using the key, the data object can be retrieved from the database. For example, a database in storage system 215 may support association of keys with data elements or objects as known in the art, accordingly, association of a key with a data element may be done using known techniques. Any other system or method for associating keys with data objects may be used, e.g., pointers or references, link lists may be used, or a table where each entry includes a key and a storage address of an associated data element may be used to link or associate keys with data elements. Accordingly, associating a key with a data element as described enables a DAC 315 to retrieve an object using a key.

To provide or transmit a key to a processing unit, e.g., provide a key 131 to GPU 310, controller 105 may store the key 131 or key value in DAC 315, e.g., in a memory 120 included in DAC 315. To use a key, a processing unit, e.g., GPU 310, may provide a key 131 to storage system, e.g., over 1/0 path 340 For example, a database in storage system 215 may support a request for data that includes a key, e.g., as known in the art, accordingly, a GPU 310 may use a key 131 to retrieve a data element 132 from storage system 215.

It will be noted that system 300 enables a data write path of data that is directly from controller 105 to storage system 215, that is, the data write path is not via, and does not involve, a GPU 310. It will further be noted that system 300 enables a data read path that is directly between a GPU 310 and storage system 215, that is, controller 105 is not involved in a data read path and data read by a GPU 310, from storage system 215, does not go through controller 105 (as is the case in current or known systems).

In some embodiments, the components shown in FIG. 3 are included in the same or single chip, package or component as opposed to for example being separated on different chips or packages and connected by wiring external to chips. For example, controller 105 and a number of GPU 310 may be included in a single chip, card or board (in which case the components may be on different chips connected by external wiring) or any suitable component.

In some embodiments, the components shown in FIG. 3 may be distributed over a number of chips or systems. For example, one or more of connections 320, 330 and 340 may be a network connection such that, in a system 300, controller 105 may be in a first component or computer, GPU 315 may be on a card in another computer and storage system 215 may be a network storage device. In another example, controller 105 may be included in a first chip or package and a processing unit such as GPU 310 may be included in a second chip or package.

Although GPUs and FPGAs are the processing units mainly described herein, it will be understood that any applicable processing units may be included in a system, e.g., a DAC 315 may be included in an ASIC or any other chip or system.

In some embodiment, storing data, e.g., by controller 105 as described, is according to a write path which is different from a read path used for retrieving the data by a processing unit, e.g., by GPU 310. For example, a write path (e.g., connection 330) may be, or may include, a first set of physical connectors, wires, lines or pins connecting controller 105 to storage 215 and a read path (e.g., connection 340) may be, or may include, a second (different and separate from the first set) set of physical connectors, wires, lines or pins connecting a GPU 310 to storage 215, accordingly, the read and write paths may be different and/or separated. In some embodiments a GPU 310 may never need, or be required to, write data to storage 215, accordingly, in some embodiments, a read path connecting GPU 310 with storage system 215 may be a unidirectional, fast and efficient component.

It is noted that although, for the sake of clarity and simplicity, a single storage system 215 is shown as included in system 300, any number of storage systems (some of which may be remote) may be included in a system 300, that is, controller 105 may write data objects with associated keys to any number of connected storage systems and, using keys as described, GPUs 310 may read data objects from any number of data storage systems.

As described, embodiments of the invention improve the field of data storage by providing an efficient and high-bandwidth interface from processing units (e.g. GPUs and FPGAs) to distributed storage systems. A further improvement is achieved by reducing CPU load in environments that deploy GPUs and FPGAs, for example, since controller 105 is not part of a read path as described, the load on controller 105 is dramatically reduced. Moreover, direct access from GPUs and FPGAs to storage as described reduces 10 overhead, improves performance and eliminates stalls due to data bottlenecks, while, at the same time, such direct access also reduces overall infrastructure costs.

In some embodiment, providing a key, by a controller to a processing unit, includes directly accessing, by the controller, a memory of the processing unit. For example, to provide a key 131 associated a data element 132 to DAC 315, controller 105 may directly write the key to a memory 120 of DAC 315, that is, the write operation may be performed without any involvement, effort or awareness of DAC 315. Accordingly, the tasks of PU 310 may be reduced to reading keys 131 from its memory, retrieving data using the keys and processing the data.

Some embodiment may include: associating, by a controller, a data element with a key and storing the data element in a storage system; and commanding a processing unit to process the data element. Commanding a processing unit to process a data element may include providing a key and using the key, by the processing unit, to retrieve the data element. For example, to cause a PU 310 to process a data element 132, e.g., an image, controller 105 may write a key 131 to a memory 120 of PU 310 and may then command PU 310 to process the data element 132 which is associated with the key 131.

In some embodiment, a write path includes a first set of physical lines and a read path includes a second, different and separate, set of physical lines. For example, write path 330 may be, or may include, a first set of physical, hardware wires or conductors and read path 340 may be, or may include, a second, different set of physical, hardware wires or conductors.

In some embodiment a controller is configured or adapted to provide keys to a plurality of processing units. For example, e.g., as shown in FIG. 3, controller 105 may associate a set of keys 131 with a respective set of data elements 132, store the set of data elements 132 in storage 215 and provide a first subset of the keys 131 to a first one of the four PU 310 shown in FIG. 3 and provide a second subset of the keys 131 to a second, different one of the four PU 310 shown in FIG. 3. Accordingly, by distributing keys 131 over a set of PU 310 units, controller 105 may control the work load distribution over a set of PU 310 units.

In some embodiments, a method of storing and retrieving data elements may include receiving, by a controller, a set of data elements to be stored in a storage system; associating the set of data elements with a respective set of keys and storing the data elements in the storage system; and selecting at least one of the keys, by the controller, and providing the selected key to a selected one of a set of processing units. A key may be used, by a selected processing unit, to retrieve one of the data elements included in the set, from the storage system.

Selecting a key (to thus select the associated or linked data element 132) may be based on a selected one of the set of processing units. For example, controller 105 may balance a work load of GPUs 310 by selecting keys and providing them to GPUs 310 such that the processing load is shared by GPUs in a most efficient way, in other cases, a specific type of data elements 132 may be provided to a specific one of GPUs 310, e.g., some of GPUs 310 may be specific, dedicated GPUs specifically adapted to process specific types of data.

Controller 105 may first select one of GPUs 310, e.g., one which is idle, and then, based on the type of the selected GPU, select (and provide the selected GPU with) a key to thus cause the selected GPU to process the associated data element 132. Controller 105 may first a key, e.g., from a stack or list of keys awaiting handling and then, based on the type of the associated data element 132, select one of PGUs 310, e.g., according to a load balancing scheme, per type of data as described etc.

For example, controller 105 may associate a first key 131 with a first data element 132 and associate a second key 131 with a second data element 132, may store the first and second data elements in storage 215, may provide the first key to a first one of a set of PU 310 units (e.g., a set of four PUs 310 as shown in FIG. 3) and provide the second key 131 to a second, different PU 310 unit in the set of PUs 310.

In the description and claims of the present application, each of the verbs, “comprise” “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Reference is made to FIG. 4, a flowchart of a method according to illustrative embodiments of the present invention. As shown by block 410, data to be stored in a storage system may be received, by a controller. For example, controller 105 may receive a data element 132 to be stored in storage system 215. As shown by block 420, the data may be associated with a key and may be stored in a storage system. For example, controller 105 may associated data elements 132 with keys 131 and store the data elements 132 in storage system 215. As shown by block 430, a key may be provided, by a controller, to a processing unit. For example, controller 105 may provide a key 131 to a GPU 310. As shown by block 440, a key may be used, by a processing unit, to retrieve the data from the storage system. For example, a GPU 310 may use a key 131 received from controller 105 to retrieve a data element 132.

Descriptions of embodiments of the invention in the present application are provided by way of example and are not intended to limit the scope of the invention. The described embodiments comprise different features, not all of which are required in all embodiments. Some embodiments utilize only some of the features or possible combinations of the features. Variations of embodiments of the invention that are described, and embodiments comprising different combinations of features noted in the described embodiments, will occur to a person having ordinary skill in the art. The scope of the invention is limited only by the claims.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A computer-implemented method of storing and retrieving data, the method comprising:
receiving, by a controller, data to be stored in a storage system;
associating the data with a key and storing the data in the storage system;
providing the key, by the controller, to a processing unit; and
using the key, by the processing unit, to retrieve the data from the storage system.

2. The method of claim 1, wherein the controller and the processing unit are included in the same chip.

3. The method of claim 1, wherein the controller is included in a first chip and the processing unit is included in a second chip.

4. The method of claim 1, wherein the processing unit is one of: a graphics processing unit (GPU), a field-programmable gate array (FPGA) and an application-specific integrated circuit (ASIC).

5. The method of claim 1, wherein storing the data by the controller is according to a write path which is different from a read path used for retrieving the data by the processing unit.

6. The method of claim 5, wherein the write path includes a first set of physical lines and wherein the read path includes a second, different and separate, set of physical lines.

7. The method of claim 1, wherein providing the key includes directly accessing, by the controller, a memory of the processing unit.

8. The method of claim 1, comprising:
associating, by the controller, a data object with a key and storing the data in the storage system; and
commanding the processing unit to process the data object;
wherein the commanding includes providing the key and wherein the key is used, by the processing unit, to retrieve the data object.

9. The method of claim 1, wherein the controller is adapted to provide keys to a plurality of processing units.

10. A computer-implemented method of storing and retrieving data elements, the method comprising:
receiving, by a controller, a set of data elements to be stored in a storage system;
associating the set of data elements with a respective set of keys and storing the data elements in the storage system;
selecting at least one of the keys, by the controller, and providing the selected key to a selected one of a set of processing units; and
using the key, by selected processing unit, to retrieve a data element included in the set, from the storage system.

11. A system comprising:
a processing unit; and
a controller configured to:
receive a data element to be stored in a storage system;
associate the data element with a key and store the data in the storage system; and
provide the key to the processing unit;
wherein the processing unit is adapted to use the key to retrieve the data from the storage system.

12. The system of claim 11, wherein the controller and the processing unit are included in the same chip.

13. The system of claim 11, wherein the controller is included in a first chip and the processing unit is included in a second chip.

14. The system of claim 11, wherein the processing unit is one of: a graphics processing unit (GPU), a field-programmable gate array (FPGA) and an application-specific integrated circuit (ASIC).

15. The system of claim 11, wherein storing the data by the controller is performed using a write path which is different from a read path used for retrieving the data by the processing unit.

16. The method of claim 15, wherein the write path includes a first set of physical lines and wherein the read path includes a second, different and separate, set of physical lines.

17. The system of claim 11, wherein providing the key includes directly accessing, by the controller, a memory of the processing unit.

18. The system of claim 11, wherein the controller is further adapted to:
associate a data element with a key and store the data element in the storage system; and
command the processing unit to process the data element;
wherein the command includes the key and wherein the key is used, by the processing unit, to retrieve the data element.

19. The system of claim 11, wherein the controller is adapted to provide keys to a plurality of processing units.
